(19) United States
(12) Patent Application Publication
(10) Pub. No.: US 2012/0259791 A1
(43) Pub. Date: Oct. 11, 2012

(54) SYSTEM AND METHOD FOR SOCIAL NETWORKING

(76) Inventor: Sabina Zoidze, Miami, FL (US)

(21) Appl. No.: 13/442,785

(22) Filed: Apr. 9, 2012

Related U.S. Application Data
(60) Provisional application No. 61/516,733, filed on Apr. 7, 2011.

(51) Int. Cl. G06Q 50/10; G06Q 99/00

(52) U.S. Cl. 705/319

(57) ABSTRACT

A system and method of the present invention pertains to a mobile social networking application intended to be used by the members of a social network as a tool for trading personal services and offering services between each other. The system allows each user to automatically locate other users located within specified radius and offering services that the user desires to benefit from. Each user creates a profile that includes user's personal information such, as for example, name, gender, address, phone number, hobbies, college information, and more importantly the list of services the user can offer and services that the user is looking to receive or benefit from.

### RELATED APPLICATIONS

This is a non-provisional application that claims priority to a provisional application Ser. No. 61/516,733 filed on Apr. 7, 2011 and incorporated herewith by reference in its entirety.

### FIELD OF INVENTION

The present invention relates to a system and method for web-based social networking and more particularly to a system and method for sharing information between members of a social network.

### BACKGROUND OF THE INVENTION

Today, social networking services play important part in day to day activities of people. These social networking services allow people to create and join social groups with common interests and activities or simply to meet each other and form personal relationship. Most of the social networking services are web based, where users form virtual communities, make friends, and look for other users with common interests, share information between each other, build up relationship, etc.

The art is replete with various prior art references related to numerous systems and methods for social networking. These prior art references include and are not limited to U.S. Pat. No. 6,549,768 to Fraccaroli, U.S. Pat. Nos. 6,711,414 and 6,757,719 to Lightman et al., U.S. Pat. No. 6,977,612 to Bennet, U.S. Pat. No. 6,996,402 to Logan, U.S. Pat. No. 6,618,593 to Drutman, U.S. Pat. Nos. 6,419,217 and 6,758,397 to Catan, U.S. Pat. No. 6,819,919 to Tanaka, U.S. Pat. Nos. 7,098,793 and 6,961,000 both to Chung, U.S. Pat. No. 6,992,574 to Aupperle, et al., U.S. Pat. No. 7,092,002 to Ferren et al., and U.S. Pat. No. 7,609,167 to Light et al., U.S. Pat. No. 7,809,805 to Stremel et al. and United States Patent Application Nos. 20070030824 filed by Ribaudo et al. and 20080140650 filed by Stackpole.

U.S. Pat. No. 6,549,768 to Fraccaroli, for example, teaches a wireless communications network having a server in a central location storing matching profiles for a plurality of users of the network. The matching profile for each user is stored in the server through the user's mobile unit or a secure page on the Internet. Each matching profile is corresponded with a respective mobile unit using the same identification information (ID) of the respective mobile unit utilized for carrying out phone calls. The server has a customizable variable matching algorithm and probes the matching profiles corresponding to the respective mobile units in a cell or group of cells for a match every time a new mobile unit subscribes into the cell or group of cells. When there is a match of matching profiles, the two persons are put in contact or advised of each other through a phone call or other communications method.

Another prior art reference, U.S. Pat. No. 6,819,919 to Tanaka teaches a system enabling mobile wireless users to obtain information on other proximate users both fixed and wireless. The information is gathered from a central database that stores user profiles and real-time locations of system users. Mobile users can request information on nearby users by submitting a request from a mobile telephone or similar communications endpoint to the central database. The request is accompanied by the user's location, obtained from GPS (Global Positioning System) or other technology, or from user input. The server searches the profile database for nearby users based on requester's location, locations of other users of the system and optional parameters specified in the request. Search results are returned to the requester. The system facilitates communication between requester and owner(s) of profiles returned by system.

Once the user has submitted a request, he or she receives a reply from the server containing accessible portions of Public Images of other users matching the requesters query. The user reviews the search results via the MU and interacts with the search results much in the same way WWW users interact with results from search engines. The user views the Public Images and decides whether or not to request to contact the owner of a specific Public Image. The request to contact the owner of a Public Image is initiated by sending the requester's (Person A) Public Image to the desired recipient (Person B). If Person B is not a member of any access control group previously defined by Person A, Person B accesses Person As Public Image with “Public” access permissions, containing the most limited information from Person A's Public Image. Included in this request for contact is a list of preferred means of contacting Person A. Person B can choose to accept or reject the request for contact from Person A. If Person B chooses to accept the request, Person B must choose a method of responding. The system supports secure contact, in which no personal contact information is disclosed. For example, an email message can be sent through the server without revealing either person's private email address or location. Contact can also be initiated through Caller-ID blocked phone calls or any other means. Consequently, Person A and Person B can choose to initiate face-to-face contact.

U.S. Pat. No. 7,609,167 to Light et al. teaches a network wherein a subscriber's computer is associated with a subscriber identifier. A subscriber security profile is created in a security profile datastore, wherein the subscriber security profile comprises information indicative of a security status and wherein the subscriber security profile is associated with the subscriber's subscriber identifier. Subscriber identifiers associated with subscribers who are logged in to a website are monitored. The website defines a virtual space and the logged-in subscribers are characterized as present in the virtual space. A web page is served to the computing devices of the present subscribers via the network. An attribute is assigned to the icons of the other present subscribers having security profiles that match the security profile of the first subscriber according to security matching criteria. Selected security profile information is provided to the first subscriber of a selected one of any of the other present matching subscribers. This particular system prevents a person using his/her cell phone and without multiple steps of logging in to the system to identify a location within a proximity to the person wherein other people sharing the same background, interest, hobbies, etc. are located at the present time or visited the location or even are planning to visit location in the future.

United States Patent Application No. 20080140650 filed by Stackpole discloses a method and system for establishing a geosocial network. As taught by this prior art reference, a client application is provided on a communications device of a user seeking to establish the geosocial network. The user creates a personal profile and a preference profile using the client application. The preference profile refers to characteristics the user seeks in potential members of the geosocial network. The user transfers the personal and preference profiles to the social networking server. The social networking server registers a location and range selected by the user for the geosocial network.

The social networking server of the United States Patent Application No. 20080140650 filed by Stackpole identifies potential members within the registered location and range by matching the personal profile of each of the potential members with the preference and personal profiles of the user. The social networking server provides communications link between the user and the identified potential members upon mutual confirmation between the user and the identified potential members. Similar to the system disclosed by the U.S. Pat. No. 7,609,167 to Light et al., the system disclosed by the United States Patent Application No. 20080140650 filed by Stackpole prevents a person using his/her cell phone and without multiple steps of logging in to the system to identify a location within a proximity to the person wherein other people sharing the same background, interest, hobbies, etc. are located at the present time or visited the location or even are planning to visit location in the future.

Still another prior art reference, such as U.S. Pat. No. 7,809,805 to Stremel et al. teaches systems and methods for automatically locating web-based social network members are provided. According to one embodiment, contact content including an associated GPS identifier and status for web-based social network members located at or near the same location automatically appears on a GPS-enabled device. The system includes a GPS-enabled device configured to receive a GPS identifier and a status representing a location and a current state for a web-based social network member, a processing module that associates the received GPS-identifier and the received status, and a communications module that sends the associated GPS-identifier and status to a server comprising a web-based social network database. Contact content in a web-based social network database record in the web-based social network database is updated to include the associated GPS identifier and status for the web-based social network member.

To the extent effective and popular among users, none of the prior art listed above provides a system and method allowing the users to not only utilize the system for establishing relationship or simply to share interests, i.e. politics, art, food, but also to allow the users to offer the services and receive services in return thereby providing benefit to other users and receive benefit from other users.

Hence, there is a need for an improved method and system for location based dynamic social networking whereby a person using his/her cell phone may instantly identify a person based on predetermined or identified location within a proximity to the person wherein other people provide services that the person is in need or wants to offer.

### SUMMARY OF THE INVENTION

An inventive subject matter pertains to a mobile social networking application intended to be used by the members (users) of a social network as “Service for Service” or “Skill Exchange” application. The invention teaches systems and methods for automatically locating web-based social network members based on skills or services required and offered. The system and method will be greatly appreciated by students of all educational institutions. However the invention is not limited to the users who are students of the educational institutions, such as schools, colleges, universities. The invention will be greatly appreciated by other professionals who are interested to exchange services, offer the services to others and receive services from others located within requested or specified radius.

Each user may log in through a website of the system or through other social networking websites. Each user creates a profile that includes user's personal information such as for example, a name, gender, address, phone number, hobbies, college information, and more importantly the list of services that each member can offer and a list of services what each member is looking to receive or benefit from. For example, a first user is a freshman at State University. The first user is skilled in math, physics, and chemistry. At the same time, the first user needs to improve his Spanish language skills in light of upcoming test or summer internship is Spain. The first user will complete the profile to identify his personal information and will complete “Services Offered” and “Services Needed” sections in his profile.

Another user, i.e. a second user, may be one of the students attending the State University or may attend another college or high school located in the same city or in any other location. The second user is struggling with math and needs tutoring because of upcoming midterm exams. The second user used to live is Spain and is fluent in Spanish. Hiring a tutor is expensive and not every student can afford to do so.

If both users are located within the same are they can locate each other in order to exchange the services. For example, while the first user is walking along the campus or stopped by a coffee shop, the second student may send a request to the first student and initiate a contact, i.e. agree to offer each other the services that they need. As the user signs in to the system, he or she will be able to identify other users located in the same venue where the member is located or within any radius therearound.

The invention will allow the users to “check in” into the list of locations/venues within any specified radius. The list may include venues such as movie theaters, clubs, shops, restaurants, schools, etc. The list may be updated automatically within every five minutes, ten minutes, without limiting the scope of the present invention. The users will be able to locate other users at the venue where the users “check-in”.

As the user locates another user with the services required, the user will initiate contact by sending a request to the other user via a mobile phone. The request is accompanied by the user's location, obtained from GPS (Global Positioning System) or other technology, or from the member's input. The request may be in the format of a text message, an email, an image (such as a “smiling face”), a voice greeting, and an audio greeting, and the like. Some users may “block” their profile or be visible to others as “Unknown”.

Based on the venue, each location may have different places to meet. These places may include and are not limited to an entrance, a bar, a lobby, a main dining area, etc. The user may choose the location to meet the other users assuming the other user accepted the invitation and is willing to move forward. The application may include many other options, such as a store for purchasing graphics, tunes, slogans, proverbs, etc.

The invention provides numerous advantages over the prior art systems and methods, wherein the social networking applications are used to initiate a contact in order to establish relationship and do not provide any benefits and services that users can exchange and benefit from.

Unlike other social networking applications, the invention combines first services to be offered and benefit received from the services offered wherein each user offers services and receives services in Again, entertainment, such as “Ice Breaking” and dating may come along with the services provided between the users.

Unlike other social networking applications, which attract only those who are interested in dating relationships, the invention will attract larger spectrum of the users because if the user is not interesting in any type of relationship he/she may still be interested to offer his/her services or simply benefit from the services of others.

Another advantage of the present invention is the application that will be very well received and encouraged by both parents and educational institutions. Our invention will be very well received by parents. Moreover, parents will encourage their children who attend college and need improvements in certain skills, i.e. math, geography, chemistry, etc.

The invention has great marketing advantages over other prior art applications. Unlike other social networking applications, which attract only those who are interested in dating relationships, the inventive application will attract large spectrum of users. Even if the user is not interesting in any type of relationship, the user may still be interested to offer his/her services or simply benefit from the services of others.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates an environmental view of a location depicting a first user and a screen of the cellular phone of a second user wherein the location of the first user star) at a particular street and a plurality of various establishments along the street and at intersection of that street with other streets, wherein various sections of the location are presented in different colors wherein area of the street located on the left side relative the user is presented in colors similar to the color assigned to the user;

FIG. 2 illustrates a front view of a screen of a cellular phone presenting a profile of a user as it appears on the screen with personal information about the user and inventive sections presenting services needed by the user and services that the user can offer to other users;

FIG. 3 illustrates a schematic view of the present invention;

FIG. 4 illustrates a screen of the cellular phone presenting sign in features;

FIG. 5 illustrates a screen of the cellular phone presenting home screen features;

FIG. 6 illustrates a select location screen of the cellular phone;

FIG. 7 illustrates a meet location screen of the cellular phone;

FIG. 8 illustrates a check in screen of the cellular phone;

FIG. 9 illustrates a club screen of the cellular phone;

FIG. 10 illustrates a user info screen of the cellular phone;

FIG. 11 illustrates an activity log screen of the cellular phone;

FIG. 12 illustrates a chat screen of the cellular phone;

FIG. 13 illustrates a guest screen of the cellular phone;

FIG. 14 illustrates an unblock screen of the cellular phone;

FIGS. 15 and 16 illustrate additional screens of the cellular phone; and

FIGS. 17 through 25 illustrate screens of alternative embodiments of the present invention.

### DETAILED DESCRIPTION OF THE INVENTION

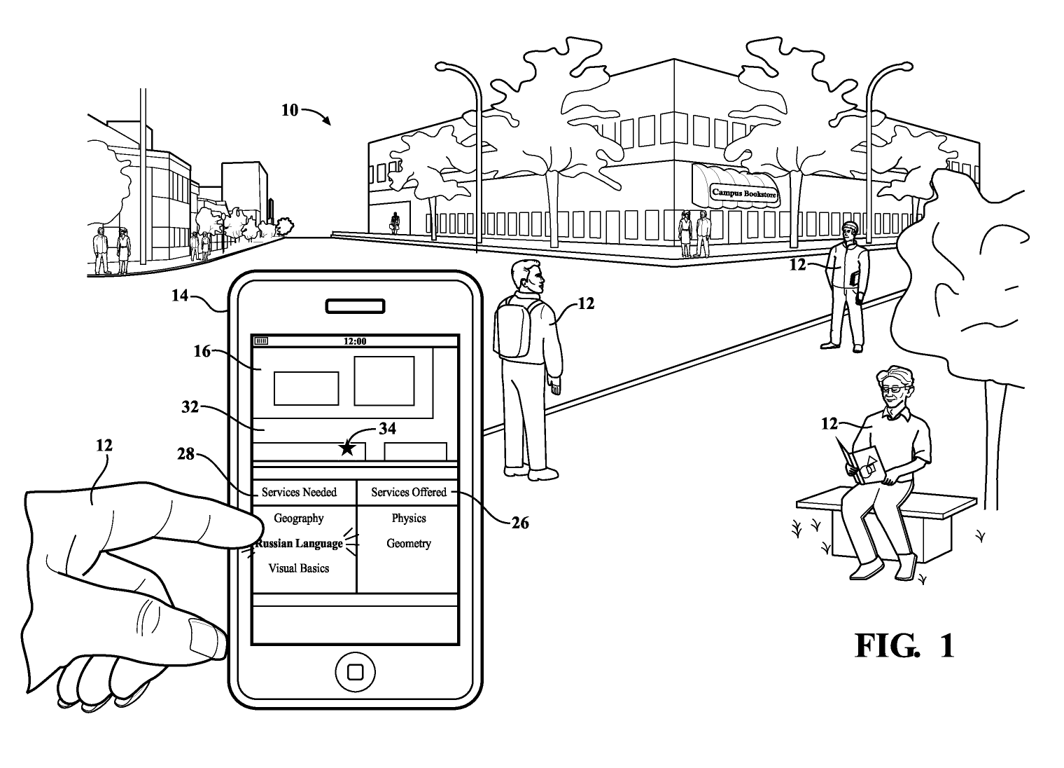

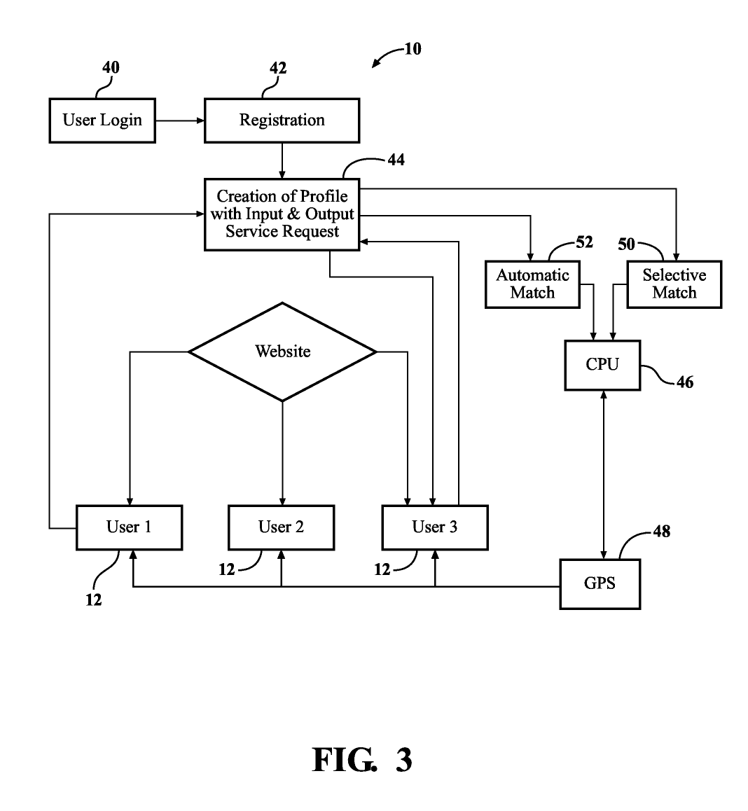

Referring to Figures, wherein like numerals indicate like or corresponding parts, a system and method of the present invention is generally shown at 10 in FIGS. 1 and 3. The inventive subject matter pertains to a mobile social networking application intended to be used by the members (users) 12 of a social network as “Service for Service” or “Skill Exchange” application. The invention teaches systems and methods for automatically locating web-based social network users 12 based on skills or services required and offered. The system and method will be greatly appreciated by students of all educational institutions. However the invention is not limited to the users 12 who are students of the educational institutions, such as schools, colleges, universities. The invention will be greatly appreciated by other professionals who are interested to exchange services, offer the services to others and receive services from others located within requested or specified radius.

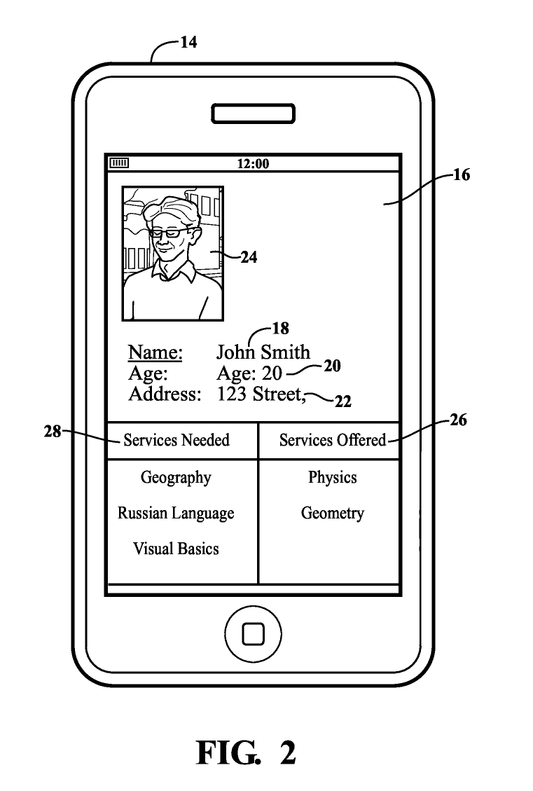

Each user 12 may log in through a website of the system or through other social networking websites. FIGS. 1 and 2 illustrate a screen of a communication device, such as a cellular phone 14. Those skilled in the art will appreciate that other communication devices such as a desktop computer, a laptop computer, a mobile phone, and a smart phone may be used without limiting the scope of the present invention. As shown in FIG. 2, each user 12 creates a profile exposed on a screen 16 that includes user's personal information such as for example, a name 18, age 20, address 22, a picture 24, and other information not shown on FIG. 2 such as a gender, a phone number, hobbies, college information, and all services that the user 12 is looking to offer to other students and the services that the user 12 is looking to benefit from. The subscriber records data store have a program includes a subscriber profile for each subscriber associated with a subscriber identifier.

The program includes a plurality of other questions designed to receive characteristic data and preference data from the user 12. The characteristic data may include and is not limited to age, marital status, physical size, physical limitations, religion, sexual orientation, etc. Preference data, for example, may include information relevant to establishing a business relationship such as for example, type of profession of a potential subscriber, type of business that the potential subscriber is engaged in, educational level of the potential subscriber, etc. Preference data may also include social relationship and information related questions to preferences of the potential subscriber. The invention will allow the users to “check in” into the list of locations/venues within any specified radius. The list may include venues such as movie theaters, clubs, shops, restaurants, schools, etc. The list may be updated automatically within every five minutes, ten minutes, without limiting the scope of the present invention. The users will be able to locate other users at the venue where the users “check-in”.

The list of the services, both offered and to be benefit from, include and are not limited to all subjects taught by the educational institutions or simply the services that are not taught by can be used in everyday life. The services are related to science, business, and languages and are not intended to limit the scope of the present invention. A pair of sections such as “Services offered” section 26 and “Services needed” section 28 will also appear on the screen 16.

For example, as best illustrated in FIG. 1, a first user 12 is a freshman at State University. The first user 12 is skilled in physics and geometry, as shown at 26 in the “Services offered” section on the screen 16 illustrated in FIG. 2. At the same time, the first user 12 takes classes in geography, Russian language, and visual basic and needs to improve his skills in these areas. He will list these subjects that he needs improvements in the “Services needed” section 28.

Another user, i.e. a second user 12, may be one of the students attending the State University or may attend another college or high school located in the same city or in any other location. The second user 12 is struggling with physics or geometry and needs tutoring because of upcoming midterm exams. The second user 12 is also fluent in Russian and majors in geography. Hiring a tutor is expensive and not every student can afford to do so. As best illustrated in FIG. 1, both users 12 may be located within the same area. The users 12 can locate each other in order to exchange the services. For example, while the second user 12 (only partially shown) is walking along the campus or stopped by a coffee shop, the second user 12 may send a request the system 10 to identify any other users located within proximity who can offer services, such as, for example, tutoring in physics and geometry in order to initiate a contact if those users are available.

As shown in FIG. 1, the first user 12 is located within specified proximity to the second user 12. The first user, John Smith, is skilled in geometry and physics and can provide these services. At the same time, John Smith is looking to benefit from tutoring services in geography, Russian language, and visual basic. The second user 12 will send the request to the system and will view a map 30 of the location where the user 12 is positioned, a street 32 and a location 34 of the user that offers tutoring services in physics and geometry. Since the second user 12 is located within geographic proximity to the first user, the second user 12 will pull up a profile of the first user 12, i.e. John Smith, and will be able to verify the user's personal information. If the second user 12 makes a decision to use the services of the first user 12, the second user 12 will initiate a contact by sending a text message, an email, or by any other means in order to let the first user know that his services are needed. The request is accompanied by the user's location, obtained from GPS (Global Positioning System) or other technology, or from the member's input. The request may also be in the format of an image (such as a “smiling face”), a voice greeting, and an audio greeting, and the like. Some users may “block” their profile or be visible to others as “Unknown”.

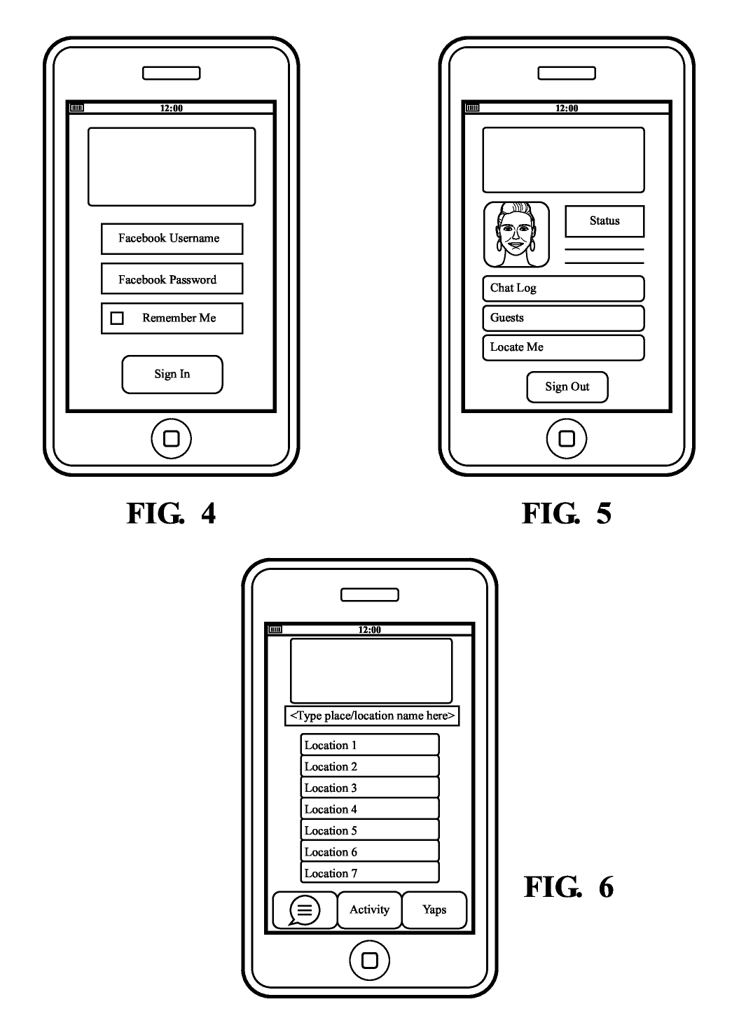

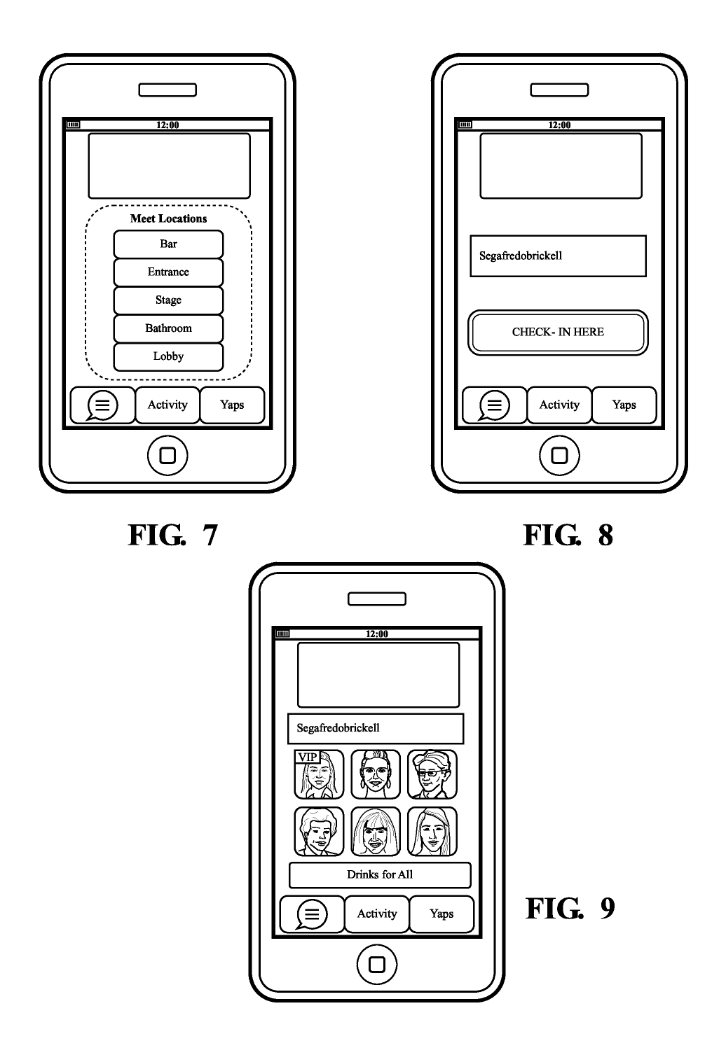

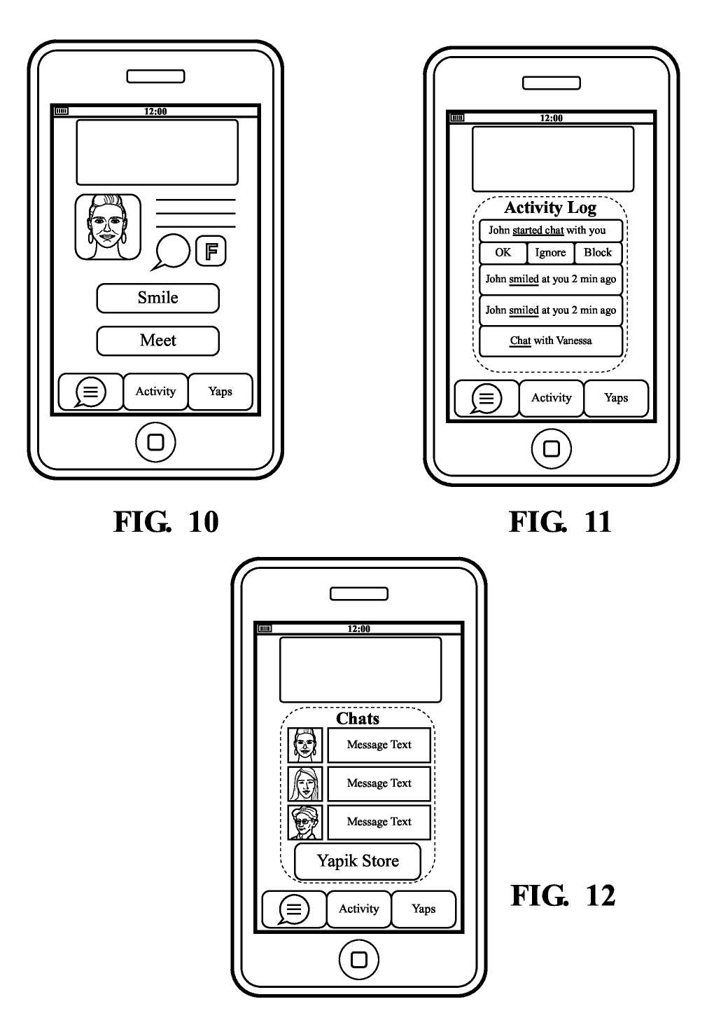

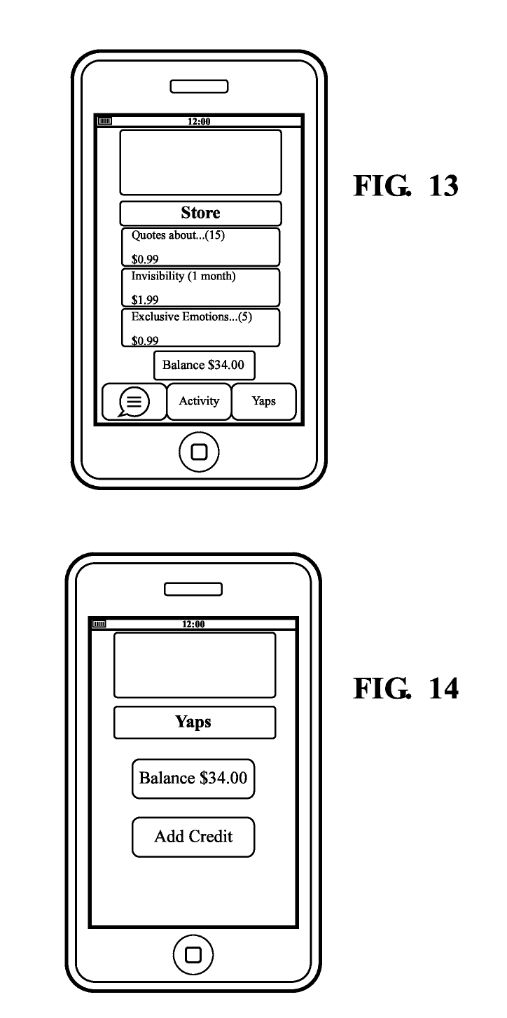

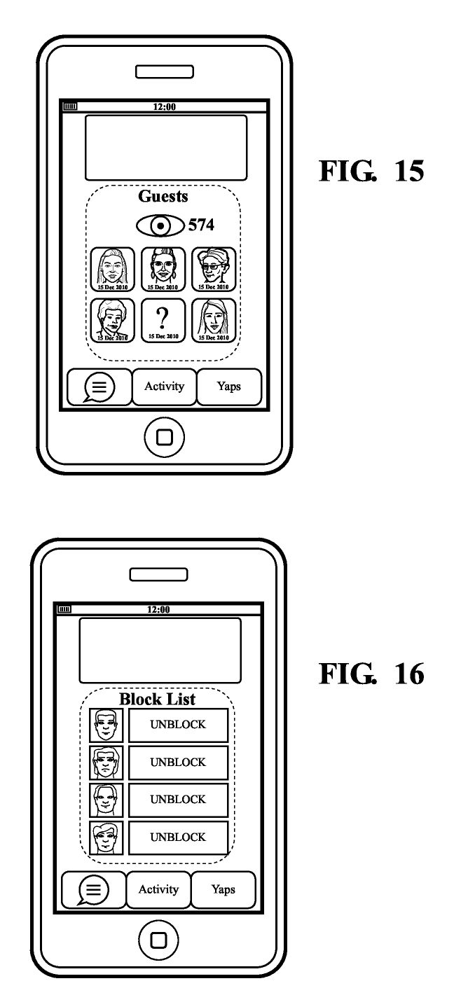

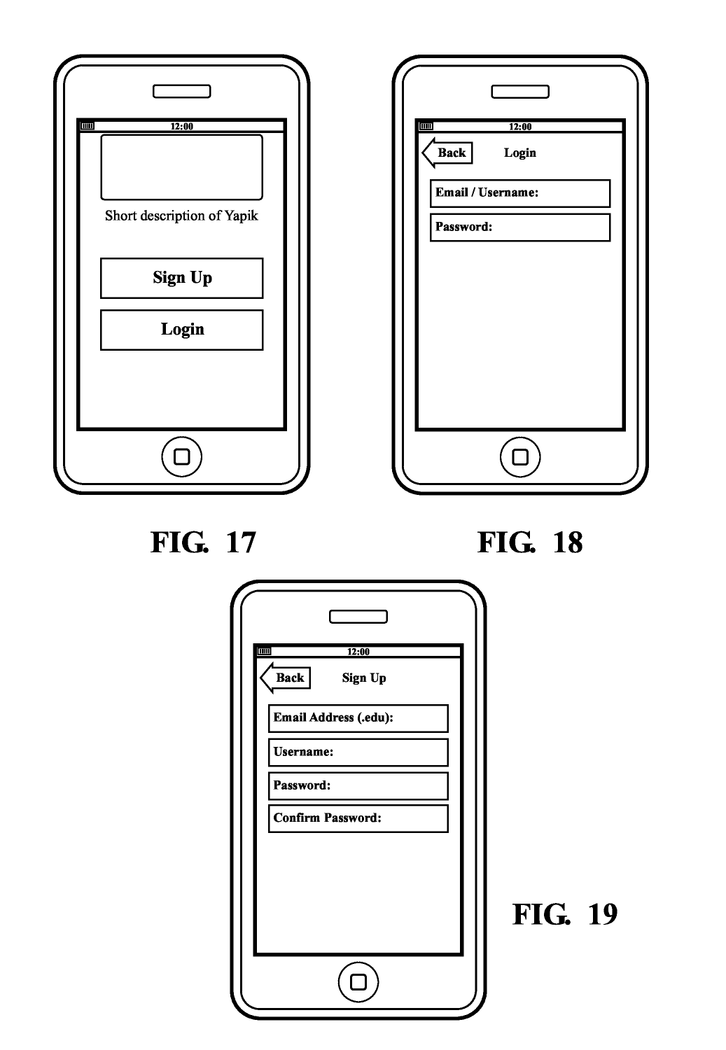

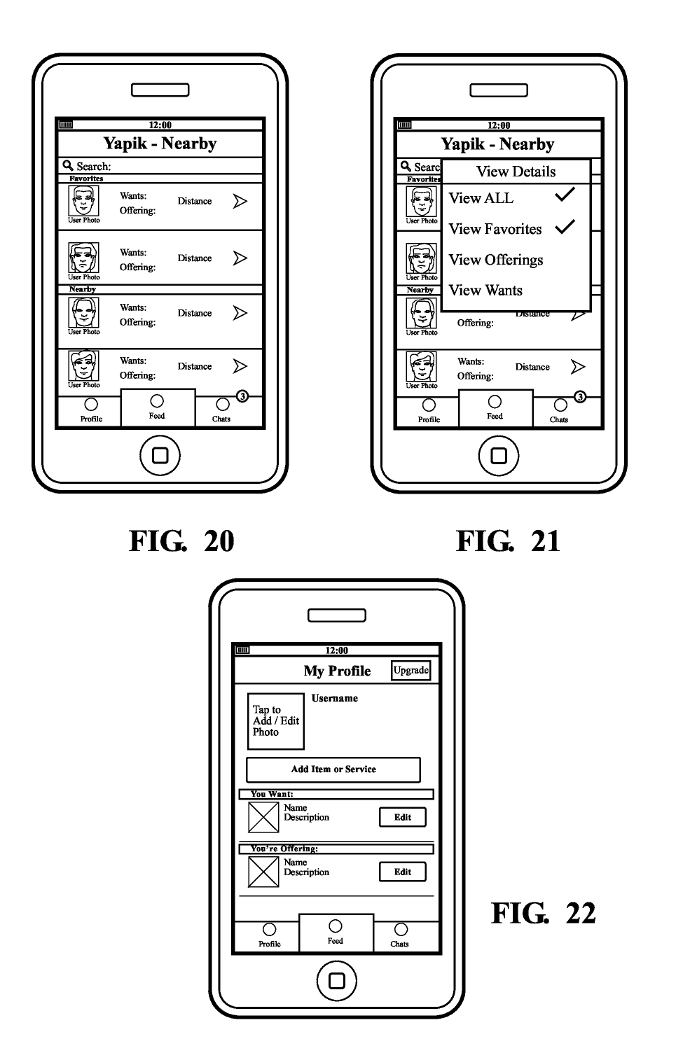

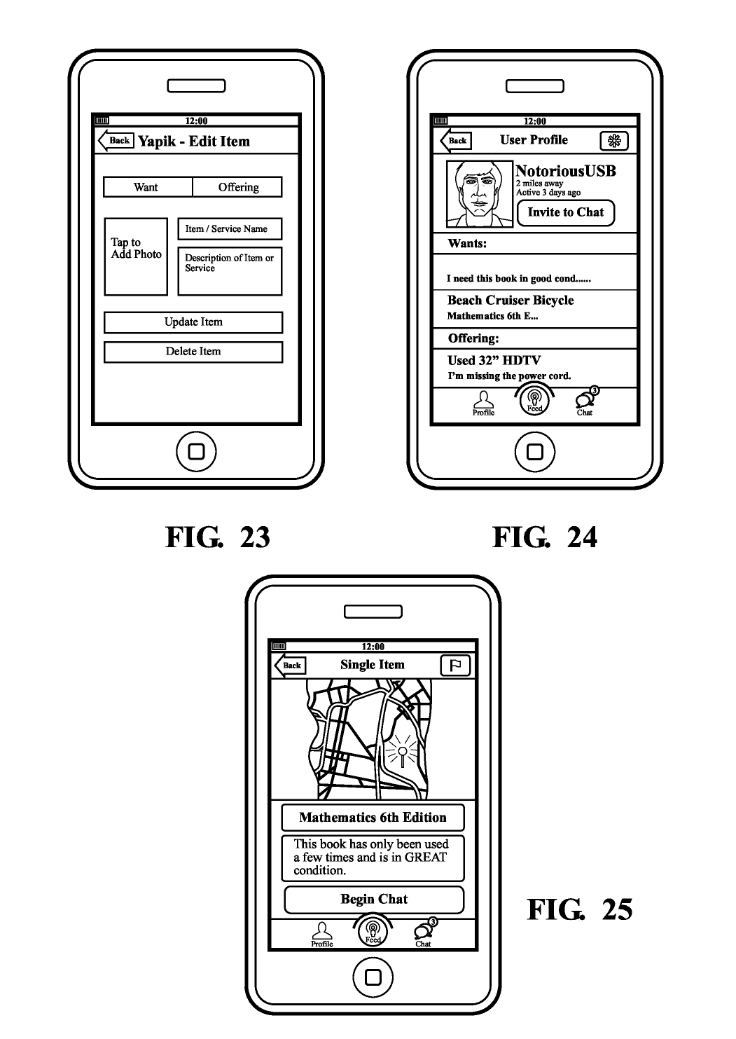

As best shown in FIG. 3, the system 10 includes several components. As the user 12 logs in to the system 10, as shown at 40, the user 12 will be required to go through a registration process, as shown at 42 where the user 12 will be ask numerous questions in order to create a profile 44. A controller or Central Processing Unit (CPU) 46 includes an information processor, a subscriber record data store, a communications system, a subscriber display manager, a subscriber input manager, a subscriber login manager, and a matching data manager defined by an automatic match program 52 that will allow the user 12 to locate all other users 12 that offer the services requested by the user. The controller 46 is cooperable with a Global Positioning System (GPS) 48 and method of the present invention provides a unique and useful tool to users/subscribers seeking to identify various venues such as shows, art galleries, restaurants, night clubs and any other venues where the users of similar type or interests have visited in the past or are currently visiting. The system 10 of the present invention can be used on any type of communications devices including and not limited to cell or cellular phones, generally indicated at 12 in FIGS. 3 through 5, mobile phones, laptops having internet connection without limiting the scope of the present invention, wherein the system 10 may employ Global Positioning System (GPS) to generate the information regarding location located within selected by the subscriber 14 distance and range to be fed to the social networking server.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for providing social networking between users subscribing to said system from communication devices, said system comprising:
a controller having a database of questions to be answered by the users to create profile of each user;
a program of said controller adaptable to store information related to skills that each user provides as services to other users and other services that each user wants to benefit from;
a global positioning system operably communicated with said controller to determine location of the user subscribed to said system and present current location of the user through the communication device of other users; and
a second program of said controller adaptable to receive input of a specified request from each user for the services that each user requires to receive and sending output of services that the user offers to other users thereby allowing each user to locate other users positioned within area specified by the user who require the services offered by another users and present services to be offered.

2. A system as set forth in claim 1, wherein each of said services represents personal skills of the user in various subjects such as educational skills, language skills, and any other subjects taught at educational institutions for those attending the educational institutions.

3. A system as set forth in claim 1, wherein each of said services represents personal skills of the user in various subjects such as professional skills.

4. A system as set forth in claim 1, wherein said communication device includes at least one of a desktop computer, a laptop computer, a mobile phone, and a smart phone.

5. A system as set forth in claim 1, wherein said second program of said controller adaptable separate the input received from the users that list the services to be benefit from and the services to be offered to others and matching the offered services and the services to be offered between the users thereby allowing each user to locate other users positioned within area specified by the user.

7. A system as set forth in claim 1, wherein the users are connected with each other through said system by a network including at least one of a wired network, a wireless network, and a fiber network.

8. A system for providing social networking between users subscribing to said system from communication devices, said system comprising:
a controller having a database of questions to be answered by the users to create profile of each user;
a global positioning system operably communicated with said controller to determine location of the user subscribed to said system and present current location of the user through the communication device of other users; and
a program of said controller adaptable to store information related to skills that each user provides as services to other users and other services that each user wants to benefit from to receive input of a specified request from each user for the services that each user requires to receive and sending output of services that the user offers to other users thereby allowing each user to locate other users positioned within area specified by the user who require the services offered by another users and present services to be offered.

9. A system as set forth in claim 8, wherein each of said services represents personal skills of the user in various subjects such as educational skills, language skills, and any other subjects taught at educational institutions for those attending the educational institutions.

10. A system as set forth in claim 8, wherein each of said services represents personal skills of the user in various subjects such as professional skills.

11. A system as set forth in claim 8, wherein said communication device includes at least one of a desktop computer, a laptop computer, a mobile phone, and a smart phone.

12. A system as set forth in claim 8, wherein said program of said controller adaptable separate the input received from the users that list the services to be benefit from and the services to be offered to others and matching the offered services and the services to be offered between the users thereby allowing each user to locate other users positioned within area specified by the user.

13. A system as set forth in claim 8, wherein the users are connected with each other through said system by a network including at least one of a wired network, a wireless network, and a fiber network.

14. A method of providing social networking between users subscribing to a system from communication devices, said method comprising the steps of:
forming a database of questions to be answered by the users to create profile of each user monitored by a controller;
connecting a global positioning system operably communicated with the controller to determine location of the user subscribed to the system and presenting current location of the user through the communication device of other users;
storing information related to skills that each user provides as services to other users and other services that each user wants to benefit from the other users; and
receive input of a specified request from each user for the services that each user requires to receive and sending output of services that the user offers to other users to matching the users positioned within area specified by the user who require the services offered by another users and present services to be offered.

15. A method as set forth in claim 14, wherein the step of storing information related to skills is further defined by storing each of the services representing personal skills of the user in various subjects such as educational skills, language skills, and any other subjects taught at educational institutions for those attending the educational institutions.

16. A method as set forth in claim 14, wherein the step of storing information related to skills is further defined by storing each of the services representing personal skills of the user in various subjects such as professional skills.

17. A method as set forth in claim 14, wherein the communication device includes at least one of a desktop computer, a laptop computer, a mobile phone, and a smart phone.

18. A method as set forth in claim 14, including the step of separating the input received from the users that list the services to be benefit from and the services to be offered to others to match the offered services and the services to be offered between the users thereby allowing each user to locate other users positioned within area specified by the user.
